(19) United States
(12) Patent Application Publication
(10) Pub. No.: US 2016/0086226 A1
(43) Pub. Date: Mar. 24, 2016

(54) EXTRACTION APPARATUS, EXTRACTION METHOD, AND NON-TRANSITORY COMPUTER READABLE STORAGE MEDIUM

(71) Applicant: YAHOO JAPAN CORPORATION, Tokyo (JP)

(72) Inventor: Shinichiro SEGA, Tokyo (JP)

(21) Appl. No.: 14/849,132

(22) Filed: Sep. 9, 2015

(30) Foreign Application Priority Data
Sep. 19, 2014 (JP) 2014-191575

(51) Int. Cl. G06Q 30/02

(52) U.S. Cl. CPC G06Q 30/0261; G06Q 30/0273; G06Q 30/0264

(57) ABSTRACT

An extraction apparatus for extracting a suitable item of advertisement content as a distribution target. The extraction apparatus according to the present application includes a calculation unit and an extraction unit. The calculation unit calculates a weight of each item of content in each time zone, based on an evaluation value of each item of content in each time zone. The extraction unit extracts an item of content to be distributed in an arbitrary time zone from the items of content, based on the weight in each time zone calculated by the calculation unit.

### CROSS-REFERENCE TO RELATED APPLICATION(S)

The present application claims priority to and incorporates by reference the entire contents of Japanese Patent Application No. 2014-191575 filed in Japan on Sep. 19, 2014.

### BACKGROUND OF THE INVENTION

1. Field of the Invention

The present invention relates to an extraction apparatus, an extraction method, and an extraction program.

2. Description of the Related Art

In recent years, with the rapid spread of the Internet, advertisement distribution through the Internet has been frequently performed. For example, advertisement distribution has been performed in which advertising content about a company, a merchandise product, or the like is displayed in an advertising spot set on an advertising medium (e.g., web page), and when a user clicks on the advertising content, the advertising spot is shifted to a web page of an advertiser.

When advertisement content is distributed, an item of advertisement content to be distributed may be extracted based on an advertisement evaluation value such as a click through rate (CTR). For example, an item of advertisement content to be distributed is extracted in descending order of CTR values (e.g., see Japanese National Publication of International Patent Application No. 2009-505246).

However, in the above-mentioned related art, a suitable item of advertisement content is not always extracted as a distribution target. Specifically, in the above-mentioned related art, the item of advertisement content to be distributed is only extracted based on the CTR obtained from a past distribution result, and the suitable item of advertisement content is not always extracted as the distribution target.

It is noted that, in the above, advertisement has been described as an example of content, in view of extraction of unsuitable item of advertisement content. However, also in content other than the advertisement, a suitable item of content may not be always extracted.

### SUMMARY OF THE INVENTION

It is an object of the present invention to at least partially solve the problems in the conventional technology.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a graph illustrating an example of an extraction process according to an embodiment;

FIG. 2 is a diagram illustrating an exemplary configuration of a distribution system according to an embodiment;

FIG. 3 is a diagram illustrating an exemplary configuration of a distribution apparatus according to an embodiment;

FIG. 4 is a table illustrating an example of an advertisement content storage unit according to an embodiment;

FIG. 5 is a table illustrating an example of a distribution result storage unit according to an embodiment;

FIG. 6 is a table illustrating an example of a weight coefficient information storage unit according to an embodiment;

FIG. 7 is a flowchart illustrating a procedure of a weight coefficient calculation process performed by the distribution apparatus according to an embodiment;

FIG. 8 is a flowchart illustrating a procedure of an advertisement content extraction process performed by the distribution apparatus according to an embodiment;

FIG. 9 is a graph illustrating a weight coefficient calculation process for each time zone having a time interval smaller than a time interval corresponding to a first time interval; and

FIG. 10 is a hardware configuration diagram illustrating an example of a embodying functions of a distribution apparatus.

### DETAILED DESCRIPTION OF THE PREFERRED EMBODIMENTS

A mode (hereinafter, referred to as “embodiment”) for carrying out an extraction apparatus, an extraction method, and an extraction program according to the present application will be described below in detail with reference to the drawings. It is noted that an extraction apparatus, an extraction method, and an extraction program according to the present application are not limited to this embodiment. Further, in the following embodiments, the same portions are denoted by the same reference signs, and repeated description thereof will be omitted.

### 1. Extraction Process

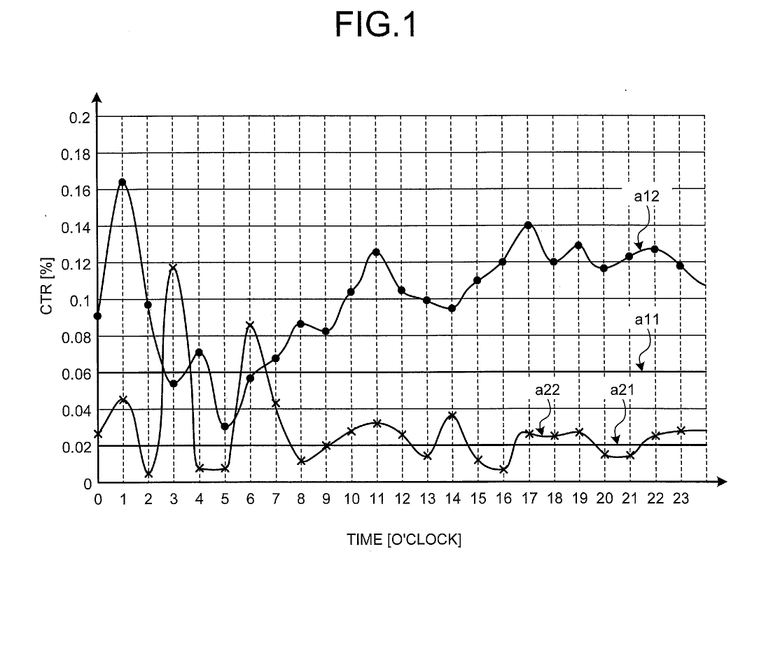

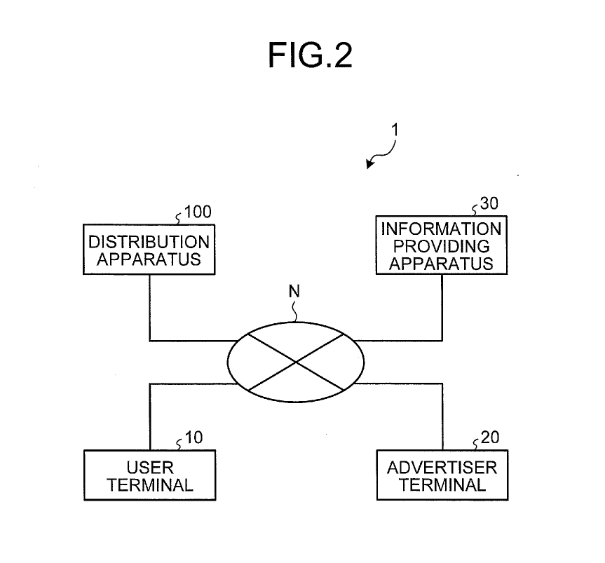

First, an example of an extraction process according to an embodiment will be described using FIG. 1. FIG. 1 is a graph illustrating an example of the extraction process according to an embodiment. In the example of FIG. 1, the extraction process is performed by a below-mentioned distribution apparatus 100 illustrated in FIG. 2. The distribution apparatus 100 extracts an item of advertisement content to be distributed, from items of advertisement content submitted by the advertiser, based on an advertisement evaluation value. The distribution apparatus 100 distributes the extracted item of advertisement content to be distributed. It is noted that, in the following embodiments, examples are provided in which a CTR is used as the advertisement evaluation value, but the distribution apparatus 100 can also use, for example, click per cost (CPC) or effective cost per mill (eCPM) as another advertisement evaluation value other than the CTR.

FIG. 1 illustrates an example of an actual value of the CTR in the advertisement content. In the graph illustrated in FIG. 1, the vertical axis represents CTR, and the horizontal axis represents time. Further, FIG. 1 is a graph illustrating the CTRs corresponding to two items of advertisement content. Specifically, graphs a11 and a12 correspond to the CTR of an advertisement content AD1, and graphs a21 and a22 correspond to the CTR of an advertisement content AD2.

First, the graphs a11 and a21 having a straight line will be described. The graph a11 illustrates the CTR obtained by dividing “total number of clicks” for the advertisement content AD1 distributed in the past, by “total number of impressions”. That is, the graph a11 illustrates one value as the actual value of the CTR in the advertisement content AD1. Similarly, the graph a21 illustrates the CTR obtained by dividing the “total number of clicks” for the advertisement content AD2 distributed in the past, by “total number of impressions”. It is noted that, in the example of FIG. 1, the graph a11 indicates a CTR of “0.06”, and the graph a21 indicates a CTR of “0.02”.

Here, it is also considered that the item of advertisement content to be distributed is extracted, based on CTRs illustrated in graphs a11 and a21. It is noted that, when the item of advertisement content to be distributed is extracted, for example, various parameters such as targeting criteria received from advertiser may be taken into consideration, but here, a parameter other than the CTR is not taken into consideration. Further, in the following, an example of distribution of any of the advertisement content AD1 and AD2 will be described for simplicity of description.

In this example, the item of advertisement content having a higher CTR is assumed to be preferentially extracted as the advertisement content to be distributed. That is, in the example of FIG. 1, since the CTR of the advertisement content AD1 is higher than the CTR of the advertisement content AD2, the advertisement content AD1 is preferentially extracted as the advertisement content to be distributed in any time zone.

For example, it is assumed that a cost per click or an advertising budget is set by the advertiser to each item of advertisement content. Here, the cost per click represents a fee charged by an advertisement distributor to the advertiser, when the advertisement content is clicked once. Further, the advertising budget represents the upper limit of the advertiser's cost of distributing an advertisement (i.e., a fee charged by the advertisement distributor). Advertisement content for which a fee is charged to the advertiser and in which the fee reaches advertising budget by clicking the advertisement content is excluded from the distribution target. That is, in the example of FIG. 1, it is considered that the advertisement content AD1 is distributed prior to the advertisement content AD2, and after the fee charged for the advertisement content AD1 reaches the advertising budget, the advertisement content AD2 is distributed. However, even if the advertisement content AD2 is distributed, the advertisement content AD2 is not always clicked easily, in a time zone after the fee charged for the advertisement content AD1 reaches the advertising budget.

Here, it is assumed that the CTR is calculated for each one-hour time zone in the day. In the example of FIG. 1, the graph a12 is assumed to illustrate the CTR of the advertisement content AD1 in each time zone, and the graph a22 is assumed to illustrate the CTR of the advertisement content AD2 in each time zone. Referring to the CTRs in the time zones, as in this example, may show that the CTR of the advertisement content AD2 is higher than the CTR of the advertisement content AD1 depending on hours. For example, between two o'clock and four o'clock and between five o'clock and seven o'clock, the CTR of the advertisement content AD2 is higher than the CTR of the advertisement content AD1. Accordingly, it is considered that when the advertisement content AD2 is extracted as the advertisement content to be distributed, rather than the advertisement content AD1, between two o'clock and four o'clock, and between five o'clock and seven o'clock, further effective advertisement distribution can be provided. Therefore, in a predetermined time zone, preferential distribution of advertisement content having a higher CTR in the corresponding time zone enables the advertisement distributor to obtain a higher advertisement distribution fee from the advertiser, and further, can achieve advertisement distribution having a higher advertising effect (CTR in this example) for the advertiser. In other words, in the above example, when after seven o'clock, a fee charged for the advertisement content AD1 reaches the advertising budget, even if the advertisement content AD2 is distributed, it is difficult to say that the advertisement is effectively distributed.

Therefore, the distribution apparatus 100 according to an embodiment calculates the CTR in each time zone, and extracts an item of advertisement content to be distributed based on the calculated CTR in each time zone. Specifically, the distribution apparatus 100 calculates the CTR of each item of advertisement content in each time zone in a predetermined period, and uses the calculated CTR in each time zone to calculate the weight coefficient of each item of advertisement content in each time zone. The distribution apparatus 100 extracts an item of advertisement content to be distributed in an arbitrary time zone based on the calculated weight coefficient, and distributes the extracted item of advertisement content.

Here, the extraction process performed by the distribution apparatus 100 will be described further in detail. It is assumed that the predetermined period represents a predetermined day arbitrarily determined from past days on which the advertisement content is distributed before the extraction process is performed.

First, the distribution apparatus 100 divides the number of clicks in each time zone of the predetermined day by the number of impressions in the corresponding time zone, for each item of advertisement content, and calculates the CTR in each time zone. Further, the distribution apparatus 100 divides the total number of clicks of the day by the total number of impressions of the day, for each item of advertisement content, and calculates an entire CTR of the day (in the following embodiments, may be referred to as “entire CTR”).

Next, the distribution apparatus 100 uses the calculated entire CTR of the day and the CTR in each time zone of the day to calculate the weight coefficient. Specifically, in each item of advertisement content, the rate of the CTR in each time zone of the day to the entire CTR of the corresponding day is calculated as a weight coefficient in each time zone. Then, the distribution apparatus 100 stores the calculated weight coefficient in a predetermined storage unit.

Here, when the distribution apparatus 100 receives an acquisition request for advertisement content from a user terminal used by the user, the distribution apparatus 100 reads, from the predetermined storage unit, a weight coefficient of each item of advertisement content corresponding to a time zone in which the acquisition request is received. The distribution apparatus 100 uses the read weight coefficient and a predicted CTR for each item of advertisement content to calculate a CTR used for extraction of an item of advertisement content to be distributed (in the following embodiments, may be referred to as “distribution CTR”). Specifically, in each item of advertisement content, the distribution apparatus 100 multiplies the predicted CTR for corresponding item of advertisement content by the read weight coefficient to calculate a values as the distribution CTR. That is, the weight coefficient corrects an evaluation value of the content in a predetermined period to be an evaluation value of content in each time zone included in the predetermined period. The predicted CTR, described below, represents a CTR predicted from a CTR prediction model or the like.

The distribution apparatus 100 compares the calculated distribution CTRs for respective items of advertisement content, and extracts an item of advertisement content to be distributed. Specifically, the distribution apparatus 100 preferentially extracts an item of advertisement content having a higher distribution CTR as the advertisement content to be distributed. The distribution apparatus 100 distributes the extracted item of advertisement content to be distributed to the user terminal.

As described above, the distribution apparatus 100 according to an embodiment calculates the weight of each item of advertisement content in each time zone, based on the advertisement evaluation value (CTR in the above-mentioned example) of each item of advertisement content in each time zone, and extracts an item of the advertisement content to be distributed in an arbitrary time zone from the plurality of items of advertisement content, based on the calculated weight coefficient in each time zone.

Therefore, the distribution apparatus 100 can preferentially extract an item of advertisement content having a higher advertisement evaluation value, in a time zone in which the acquisition request for advertisement content is received. That is, the distribution apparatus 100 can prevent deviation in extraction of an item of advertisement content, e.g., extraction of a specific item of advertisement content as the distribution target in any time zone. Accordingly, the distribution apparatus 100 can extract a suitable item of advertisement content as the advertisement content to be distributed according to the time zone. Therefore, the distribution apparatus 100 can increase profits obtained by the distribution of advertisement content or can increase an advertising effect.

### 2. Structure of Distribution System

Next, a configuration of an advertisement distribution system according to an embodiment will be described, using FIG. 2. FIG. 2 is a diagram illustrating an exemplary configuration of a distribution system 1 according to an embodiment. As illustrated in FIG. 2, the distribution system 1 includes a user terminal 10, an advertiser terminal 20, an information providing apparatus 30, and the distribution apparatus 100. The user terminal 10, the advertiser terminal 20, the information providing apparatus 30, and the distribution apparatus 100 are communicably connected wiredly or wirelessly through a network N. It is noted that, the distribution system 1 illustrated in FIG. 2 may include a plurality of user terminals 10, a plurality of advertiser terminals 20, a plurality of information providing apparatuses 30, or a plurality of distribution apparatuses 100.

The user terminal 10 represents an information processing device such as a desktop personal computer (PC), a notebook PC, a tablet terminal, a mobile phone, a personal digital assistant (PDA). For example, the user terminal 10 accesses the information providing apparatus 30 to obtain a web page from the information providing apparatus 30, and displays the obtained web page on a display unit (e.g., liquid crystal display). Further, when the web page includes an advertising spot, the user terminal 10 accesses the distribution apparatus 100 to obtain advertisement content from the distribution apparatus 100, and displays the obtained advertisement content on the web page. However, the user terminal 10 is not limited to this example, and may obtain the web page including the advertisement content from the information providing apparatus 30. In this case, the web page into which the advertisement content is incorporated is distributed by the distribution apparatus 100 to the information providing apparatus 30, and the information providing apparatus 30 distributes the web page to the user terminal 10.

The advertiser terminal 20 is an information processing device used by the advertiser making a request to the distribution apparatus 100 for advertisement distribution. The advertiser terminal 20 submits advertisement content to the distribution apparatus 100, according to the operation by the advertiser. The advertiser terminal 20 according to an embodiment submits, to the distribution apparatus 100, various items of advertisement content such as a still image, a moving image, text data, or a uniform resource locator (URL) used for access to a web page provided from an advertiser server managed by the advertiser.

Further, the advertiser may request an agency to submit the advertisement content without submitting the advertisement content to the distribution apparatus 100. In this case, it is the agency to submit the advertisement content to the distribution apparatus 100. Therefore, description such as “advertiser” represents a concept including the agency in addition to the advertiser, and description such as “advertiser device” represents a concept including an agency device used by the agency in addition to the advertiser device.

The information providing apparatus 30 includes a web server or the like providing a web page to the user terminal 10. The information providing apparatus 30 provides various web pages relating to, for example a news site, an auction site, a weather forecast site, a shopping site, a finance site, a route-finding site, a map providing site, a travel site, a restaurant site, or a blog.

The distribution apparatus 100 represents a server apparatus for distributing advertisement content submitted from the advertiser terminal 20. Further, the distribution apparatus 100 accessed from the user terminal 10 distributes the advertisement content to the user terminal 10. Further, the distribution apparatus 100 accessed from the information providing apparatus 30 distributes the advertisement content to the information providing apparatus 30. It is noted that the distribution apparatus 100 is managed by an advertisement distributor or the like.

### 3. Structure of Distribution Apparatus

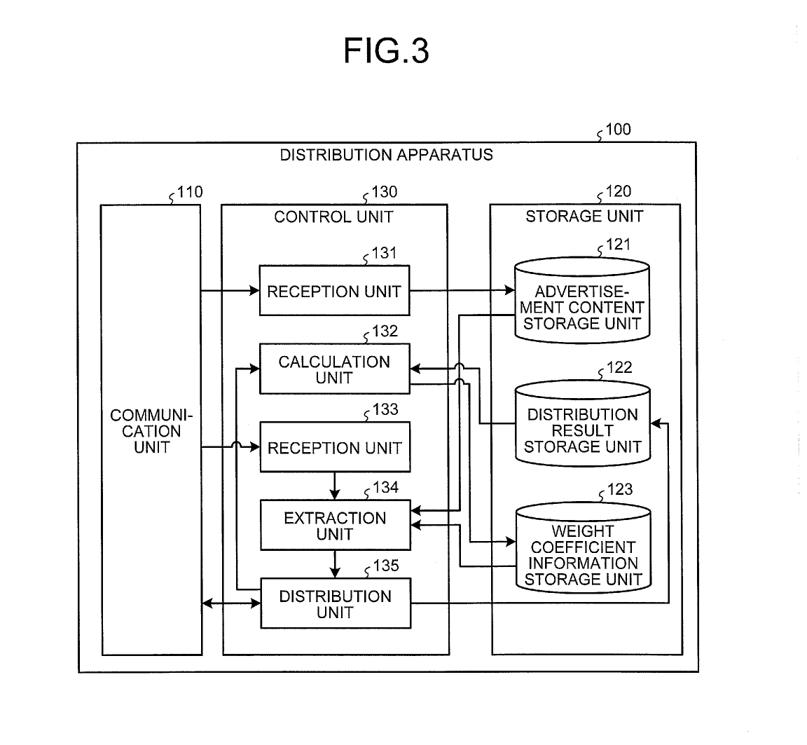

Next, a configuration of the distribution apparatus 100 according to an embodiment will be described using FIG. 3. FIG. 3 is a diagram illustrating an exemplary configuration of the distribution apparatus 100 according to an embodiment. As illustrated in FIG. 3, the distribution apparatus 100 includes a communication unit 110, a storage unit 120, and a control unit 130.

The communication unit 110 includes, for example, a network interface card (NIC). The communication unit 110 is wiredly or wirelessly connected to the network, and performs transmission and reception of information with the user terminal 10, the advertiser terminal 20, or the information providing apparatus 30, through the network N.

About Storage Unit 120

The storage unit 120 includes, for example, a semiconductor memory element such as a random access memory (RAM) or a flash memory, or a storage device such as a hard disk or an optical disk. The storage unit 120 includes an advertisement content storage unit 121, a distribution result storage unit 122, and a weight coefficient information storage unit 123.

About Advertisement Content Storage Unit 121

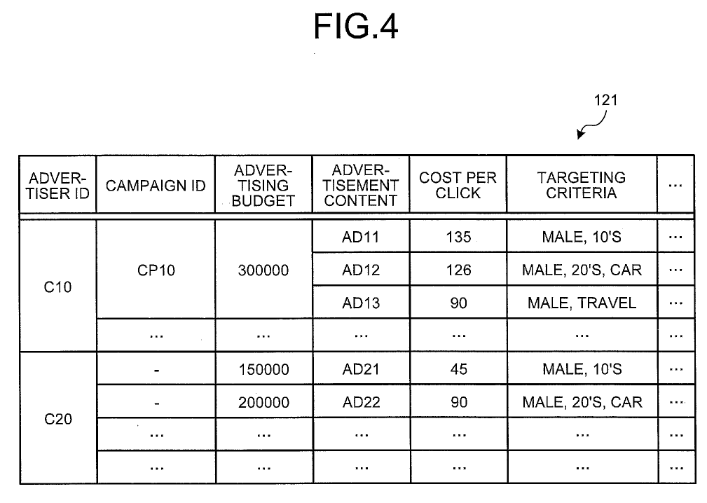

The advertisement content storage unit 121 stores the advertisement content submitted from the advertiser terminal 20. Here, FIG. 4 illustrates an example of the advertisement content storage unit 121 according to an embodiment. In the example illustrated in FIG. 4, the advertisement content storage unit 121 has items such as “advertiser ID”, “campaign ID”, “advertising budget”, “advertisement content”, “cost per click (CPC)”, and “targeting criteria”. Although not illustrated, the advertisement content storage unit 121 may store the predicted CTR described below.

The “advertiser ID” represents identification information for identifying the advertiser or the advertiser terminal 20. The “campaign ID” represents identification information for identifying an advertising campaign designated by the advertiser. In the advertising campaign, a plurality of items of advertisement content is submitted by the advertiser in order to advertise for example a specific merchandise product or service. That is, the “campaign ID” can also be said to represent identification information for identifying advertisement content group for campaign. It is noted that to the advertisement content group for campaign, the advertising budget may be set collectively. The “advertisement content” represents the advertisement content submitted from the advertiser terminal 20. In the example illustrated in FIG. 4, the “advertisement content” stores conceptual information such as an item “AD11” or “AD21”, but in fact, the “advertisement content” stores a still image, a moving image, text data, and a uniform resource locator (URL), or a file path name or the like representing the storage places of them.

The “advertising budget” represents information set when the advertiser submits the advertisement content, and shows an upper limit of an advertisement rate paid by the advertiser to the advertisement distributor. The “cost per click” corresponds to a unit price (e.g., monetary unit is “yen”) of a fee charged by the advertisement distributor to the advertiser for single click on the advertisement content by the user. The “targeting criteria” represent information set upon submission of the advertisement content by the advertiser, and show the criteria of users to whom the advertisement content is to be distributed. For example, “targeting criteria” stores user attributes of the users to whom advertisement content is to be distributed.

That is, FIG. 4 illustrates an example in which the advertiser identified by the advertiser ID “C10” submits the advertisement content group for campaign identified by the campaign ID “CP10”. Further, FIG. 4 illustrates an example in which a campaign advertisement group having the campaign ID “CP10” includes the items AD11 to AD13 of advertisement content. Further, FIG. 4 illustrates an example in which the advertiser identified by the advertiser ID “C10” designates the advertising budget “300,000 yen” for the advertisement content group for campaign identified by the campaign ID “CP10”. Further, FIG. 4 illustrates an example in which the advertiser identified by the advertiser ID “010” designates the cost per click “135 yen”, and the targeting criteria “male, 10's”, to the item AD11 of advertisement content.

About Distribution Result Storage Unit 122

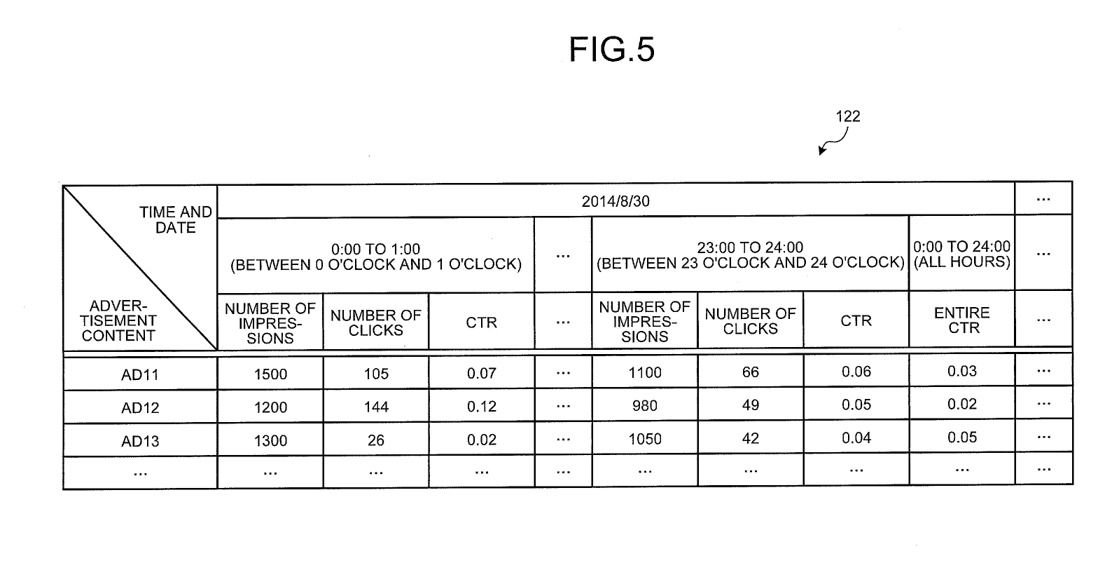

The distribution result storage unit 122 stores information about the result of the advertisement content distributed by the distribution apparatus 100. Here, FIG. 5 illustrates an example of the distribution result storage unit 122 according to an embodiment. In the example of FIG. 5, the distribution result storage unit 122 stores “number of impressions”, “number of clicks”, and a “CTR” in each one-hour time zone in 24 hours of the day (in the following embodiments, may be simply referred to as “in each time zone”), and an entire CTR of the corresponding day, for each distribution date of each item of advertisement content. Although omitted in FIG. 5, in all 24 time zones between zero o'clock and 24 o'clock, the distribution result storage unit 122 stores “number of impressions”, “number of clicks”, and a “CTR” in each time zone, for each item of advertisement content.

The “number of impressions” represents the number of times of display of advertisement content on a web page or the like. The “number of clicks” represents the number of times of clicks of a user on the advertisement content. The “CTR” represents whether advertisement content is selected (e.g., clicked) by the user of the user terminal 10, and corresponds to a value obtained by dividing the number of times of selection (i.e., number of clicks) by the number of impressions. Specifically, the CTR in each time zone is a value obtained by dividing the number of clicks in each time zone by the number of impressions in the corresponding time zone. Further, the entire CTR is a value obtained by dividing the total number of clicks as a sum of the number of clicks in the time zones by the total number of impressions as a sum of the number of impressions in the time zones.

That is, FIG. 5 illustrates an example in which the item AD11 of advertisement content has the number of impressions of “1,500”, the number of clicks of “105”, and a CTR of “0.07”, from 0:00 to 1:00 on Aug. 30, 2014 (between zero o'clock and one o'clock). Further, FIG. 5 illustrates an example in which the entire CTR of the item AD11 of advertisement content is “0.03” on Aug. 30, 2014.

About Weight Coefficient Information Storage Unit 123

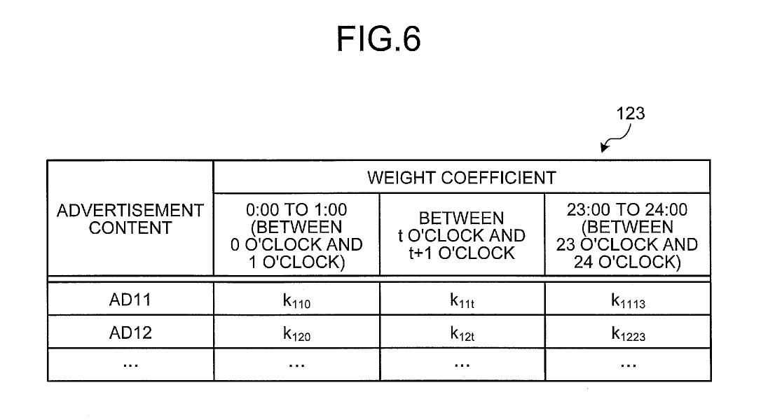

The weight coefficient information storage unit 123 stores the weight coefficient as a rate of CTRs in each time zone of the day to the entire CTR of the corresponding day. Here, FIG. 6 illustrates an example of the weight coefficient information storage unit 123 according to an embodiment. In the example illustrated in FIG. 6, the weight coefficient information storage unit 123 stores the weight coefficient in each time zone, for each item of advertisement content. Although omitted in FIG. 6, in all 24 time zones between zero o'clock and 24 o'clock, the weight coefficient information storage unit 123 stores the weight coefficient in each time zone, for each item of advertisement content.

About Control Unit 130

The control unit 130 is achieved, for example by executing various programs (corresponding to an example of the extraction program) stored in the storage device in the distribution apparatus 100 by a central processing unit (CPU), a micro processing unit (MPU), or the like, using a RAM as a working area. Further, the control unit 130 includes, for example, an integrated circuit such as an application specific integrated circuit (ASIC) or a field programmable gate array (FPGA).

As illustrated in FIG. 3, the control unit 130 includes a reception unit 131, a calculation unit 132, a reception unit 133, an extraction unit 134, and a distribution unit 135, and functionally or operationally achieves or performs information processing described below. It is noted that an internal configuration of the control unit 130 is not limited to the configuration illustrated in FIG. 3, and the control unit 130 may have another configuration as far as the configuration performs the information processing described below. Further, a connection relationship between processing units of the control unit 130 is not limited to a connection relationship illustrated in FIG. 3, and the processing units may have another connection relationship.

About Reception Unit 131

The reception unit 131 receives the submission of the advertisement content from the advertiser terminal 20, and stores the received advertisement content in the advertisement content storage unit 121. Specifically, the reception unit 131 receives the submission of the advertisement content together with the advertising budget, the cost per click, and the targeting criteria, and stores the advertising budget, the cost per click, and the targeting criteria in the advertisement content storage unit 121, corresponding to the submitted advertisement content. At this time, the reception unit 131 also stores, in the advertisement content storage unit 121, the advertiser ID corresponding to the advertiser being a submission source of the advertisement content.

Further, the reception unit 131 receives the submission of the advertisement content group for campaign from the advertiser terminal 20. Specifically, the reception unit 131 receives a plurality of items of advertisement content constituting the advertisement content group for campaign, and an advertising budget set to the campaign. In this case, the reception unit 131 stores the advertising budget, the advertisement content, the cost per click and the targeting criteria for each advertisement content, in the advertisement content storage unit 121, corresponding to the campaign ID for identifying the campaign.

About Calculation Unit 132

The calculation unit 132 calculates a weight of each item of content in each time zone, based on an evaluation value of each item of content in each time zone. Specifically, the calculation unit 132 calculates, as weight in each time zone, a rate of an evaluation value in each corresponding time zone to the evaluation value of content in a predetermined period including the corresponding time zone. It is noted that the predetermined period is a period longer than the time interval of the corresponding time zone. In the present embodiment, it is assumed that the predetermined period represents a predetermined day arbitrarily determined from past days on which the corresponding advertisement is distributed before the distribution apparatus 100 performs the extraction process.

Further, as described above, in the present embodiment, the content represents the advertisement content, and the evaluation value represents an advertisement evaluation value such as CTR. Further, in the present embodiment, a weight coefficient calculation process and an advertisement content extraction process using the CTR as the advertisement evaluation value will be described, but another advertisement evaluation value such as CPC or eCPM may be employed.

Here, the calculation process by the calculation unit 132 will be described using formula (1). The calculation unit 132 acquires the CTR in each one-hour time zone in the predetermined day, and the entire CTR of the day from the distribution result storage unit 122. The calculation unit 132 calculates, as the weight coefficient in each time zone, a rate of the CTR in each time zone of the day to the entire CTR of the corresponding day. The calculation unit 132 performs such a calculation process for all items of the advertisement content. That is, the weight coefficient kᵢₜ of the advertisement content i in a time zone t is expressed by the following formula (1).

$${k}_{it} = \frac{{CTR}_{it}}{{CTR}_{li}} = \frac{\frac{{Click}_{it}}{Im p {s}_{it}}}{\frac{\sum {Click}_{l}}{\sum Im p {s}_{l}}} \qquad ( 1 )$$

Here, “CTR₁ᵢ” represents the entire CTR of each item of advertisement content in the predetermined day. It is noted that “CTR₁ᵢ” is calculated by dividing the total number of clicks of the day by the total number of impressions of the day. Further, “CTRᵢₜ” represents CTR of the advertisement content i in the time zone t It is noted that “CTRᵢₜ” is calculated by dividing the number of clicks in the time zone t by the number of impressions in the time zone t.

The calculation unit 132 stores the calculated weight coefficient of each item of advertisement content in each time zone, in the weight coefficient information storage unit 123. Specifically, as illustrated in FIG. 6, the calculation unit 132 stores the weight coefficient in each time zone in the weight coefficient information storage unit 123, corresponding to each item of advertisement content.

Reception Unit 133

The reception unit 133 receives the acquisition request for advertisement content from the user terminal 10. For example, the reception unit 133 receives the acquisition request for advertisement content, using a hypertext transfer protocol (HTTP) request or the like.

It is noted that a device for transmitting the acquisition request for advertisement content to the reception unit 133 differs according to the web page distributed by the information providing apparatus 30. For example, when a web page in which a URL for access to the distribution apparatus 100 is embedded is distributed to the user terminal 10, the reception unit 133 receives the acquisition request for advertisement content from the user terminal 10. Further, when a web page in which the advertisement content has been already embedded is distributed to the user terminal 10, the reception unit 133 receives the acquisition request for advertisement content from the information providing apparatus 30. In the present embodiment, it is assumed that the reception unit 133 receives the acquisition request for advertisement content from the user terminal 10.

Extraction Unit 134

The extraction unit 134 extracts content to be distributed in an arbitrary time zone from multiple items of content, based on the weight in each time zone calculated by the calculation unit 132. Specifically, the extraction unit 134 uses the weight coefficient in each time zone calculated by the calculation unit 132 to correct the evaluation value of the content in the predetermined period to be the evaluation value of the content in each time zone, and extracts an item of the content to be distributed based on the corrected evaluation value.

For example, when the reception unit 133 receives the acquisition request for advertisement content from the user terminal 10, the extraction unit 134 reads a weight coefficient of each item of advertisement content corresponding to a time zone in which the acquisition request is received, from the weight coefficient information storage unit 123. Further, the extraction unit 134 acquires the predicted CTR for each item of advertisement content from a predetermined storage unit not illustrated. Although the predicted CTR will be described later, the predicted CTR may be the predicted CTR for a corresponding predetermined day, or the predicted CTR for any of the past days. Further, the predicted CTR for the day is not necessarily used. Here, it is assumed that the predicted CTR for a corresponding predetermined day is used.

The extraction unit 134 multiplies the predicted CTR for corresponding item of advertisement content by the read weight coefficient to calculate the distribution CTR used for extraction of an item of advertisement content to be distributed. That is, the distribution CTRᵢₜ for the advertisement content i in the time zone t is expressed by the following formula (2), using the weight coefficient kᵢₜ, and the predicted CTRᵢ of the advertisement content i.

Distribution CTRᵢₜ=kᵢₜ×Predicted CTRᵢ (2)

The extraction unit 134 compares the distribution CTRs for respective items of advertisement content, and extracts an item of advertisement content to be distributed. For example, the extraction unit 134 compares the calculated distribution CTRs for respective items of advertisement content, specifies a predetermined number of upper distribution CTRs having a higher numerical value, and extracts an item of advertisement content corresponding to each of the specified distribution CTRs as the advertisement content to be distributed.

As described above, the extraction unit 134 reads the weight coefficient corresponding to a time zone in which the acquisition request for advertisement content is received from the weight coefficient information storage unit 123, and multiplies the predicted CTR for the advertisement content by the read weight coefficient to calculate the distribution CTR used for extraction of the item of advertisement content to be distributed. Therefore, the extraction unit 134 can correct the predicted CTR for each item of advertisement content to the distribution CTR corresponding to the predetermined time zone.

Next, the reason for using the predicted CTR will be described. The predicted CTR represents the CTR predicted from the CTR prediction model or the like. The prediction model is generated from, for example, a distribution result of advertisement content distributed in the past. For example, the prediction model is generated based on various features such as user information (age, gender, address, or the like) of users to whom the advertisement content distributed in the past is distributed, types of the advertisement content distributed in the past, types of web pages on which the advertisement content distributed in the past is displayed. The predicted CTR corresponds to a CTR predicted, using such a prediction model, from information (e.g., user information of users as advertisement distribution destinations, types of web pages on which advertisement content is displayed) transmitted upon distribution of advertisement content, or the like.

Therefore, the extraction unit 134 can obtain a highly accurate distribution CTR, using the predicted CTR.

About Distribution Unit 135

The distribution unit 135 distributes the item of advertisement content to be distributed, extracted by the extraction unit 134, to the user terminal 10 making an advertisement content acquisition request. The distribution unit 135 updates the number of impressions of the distribution result storage unit 122, each time the advertisement content is distributed. For example, when predetermined advertisement content is distributed to 50 different user terminals 10 at “0:05”, the distribution unit 135 adds “50” to the number of impressions from 0:00 to 1:00 (between zero o'clock and one o'clock) corresponding to the predetermined advertisement content.

Further when the distributed advertisement content is clicked by the user, the distribution unit 135 receives a click report indicating click from the user terminal 10 or the like. Then, the distribution unit 135 updates the number of clicks of the distribution result storage unit 122 according to reception of the click report. For example, when receiving the click reports from “10” different user terminals 10 at “0:10”, the distribution unit 135 adds “10” to the number of clicks from 0:00 to 1:00 (between zero o'clock and one o'clock) corresponding to the predetermined advertisement content.

It is noted that the distribution unit 135 may be set not to count successive click reports about one item of advertisement content from the same user terminal 10. For example, the distribution unit 135 is set to count only first one click report, when receiving a plurality of click reports about the one item of advertisement content from the same user terminal 10, within a predetermined period. Therefore, the distribution unit 135 can prevent fraudulent click by the user.

Further, as illustrated in FIG. 5 and formula (1), the distribution unit 135 calculates the CTR in each time zone of the day, in each item of advertisement content. Further, as illustrated in formula (1), the distribution unit 135 calculates the entire CTR of the day. It is note that the distribution unit 135 calculates the CTR in each time zone, each time the advertisement content is distributed or the click report is received. Further, the distribution unit 135 is not limited to this example, and the distribution unit 135 may calculate the CTR in each time zone depending on the elapsed time and calculate the entire CTR of the day at the end of the day, or may calculate the CTR in each time zone and the entire CTR at the end of the day.

### 4. Procedure of Weight Coefficient Calculation Process

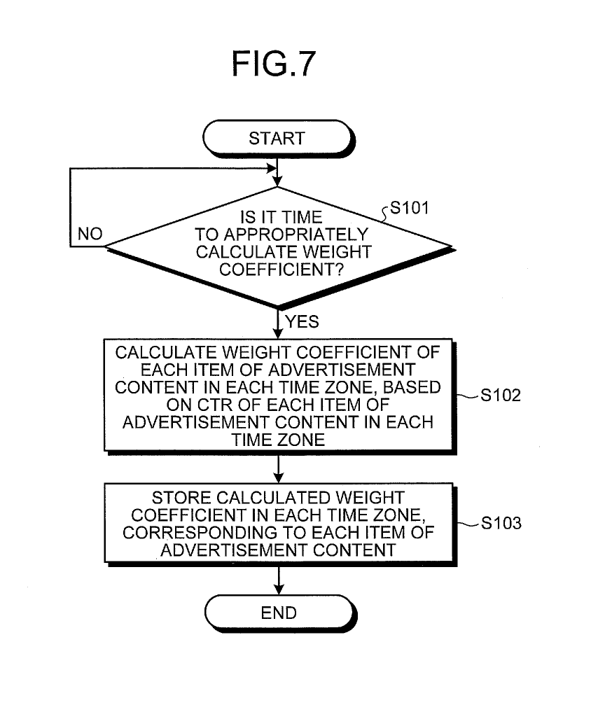

Next, a procedure of the weight coefficient calculation process performed by the distribution apparatus 100 according to an embodiment will be described, using FIG. 7. FIG. 7 is a flowchart illustrating the procedure of the weight coefficient calculation process performed by the distribution apparatus 100 according to an embodiment.

As illustrated in FIG. 7, the calculation unit 132 of the distribution apparatus 100 determines appropriate time to calculate the weight coefficient in each time zone, for each item of advertisement content (step S101). For example, when receiving an instruction for calculating the weight coefficient from the distribution unit 135 of the distribution apparatus 100, the calculation unit 132 determines that it is time to calculate the weight coefficient (step S101; Yes). Whereas, while receiving no instruction from the distribution unit 135, the calculation unit 132 stands by until receiving the instruction (step S101; No).

Then, the calculation unit 132 calculates the weight coefficient of each item of advertisement content in each time zone, based on the CTR of each item of advertisement content in each time zone (step S102). For example, the calculation unit 132 calculates, as the weight coefficient in each time zone, a rate of the CTR in each time zone of the day to the entire CTR of the corresponding day, in each item of advertisement content.

Next, the calculation unit 132 stores the calculated weight coefficient in each time zone, corresponding to each item of advertisement content (step S103).

### 5. Procedure of Content Extraction Process

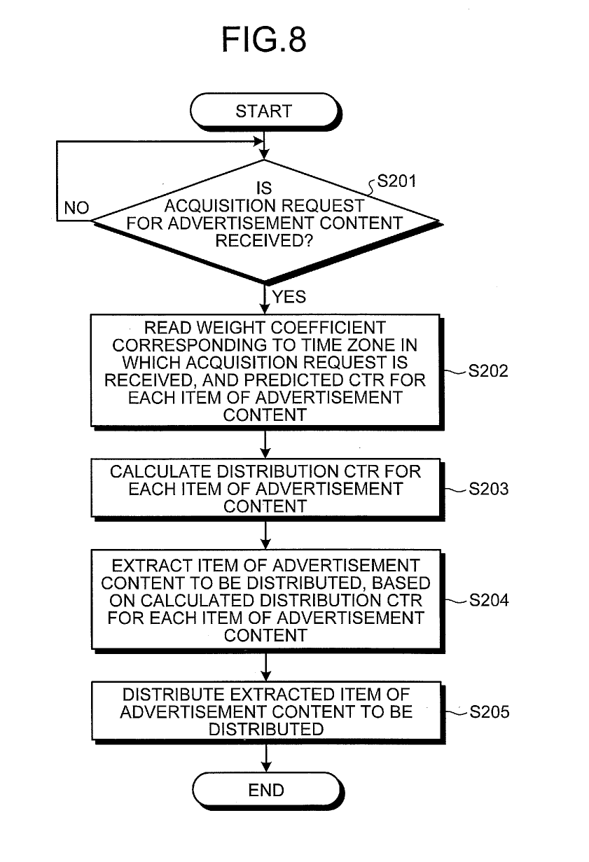

Next, a procedure of the advertisement content extraction process performed by the distribution apparatus 100 according to an embodiment will be described, using FIG. 8. FIG. 8 is a flowchart illustrating the procedure of the advertisement content extraction process performed by the distribution apparatus 100 according to an embodiment.

As illustrated in FIG. 8, the extraction unit 134 of the distribution apparatus 100 determines whether the acquisition request for advertisement content is received (step S201). For example, while the acquisition request for advertisement content is not received from the user terminal 10, the extraction unit 134 stands by until receiving the acquisition request (step S201; No).

Whereas, when the acquisition request for advertisement content is received from the user terminal 10 (step S201; Yes), the extraction unit 134 reads, from the weight coefficient information storage unit 123, the weight coefficient corresponding to a time zone in which the acquisition request is received, for each item of advertisement content, and reads the predicted CTR for each item of advertisement content (step S202). It is noted that the predicted CTR may be stored for example in the advertisement content storage unit 121.

Then, the extraction unit 134 multiplies the predicted CTR for corresponding item of advertisement content by the read weight coefficient to calculate the distribution CTR for each item of advertisement content in the time zone in which the acquisition request is received (step S203). The distribution CTR represents a CTR used for extraction of an item of advertisement content to be distributed.

Next, the extraction unit 134 extracts an item of advertisement content to be distributed based on the calculated distribution CTR for each item of advertisement content (step S204). For example, the extraction unit 134 compares the calculated distribution CTRs for respective items of advertisement content, specifies the predetermined number of upper distribution CTRs having a higher numerical value, and extracts an item of advertisement content corresponding to each of the specified distribution CTRs as the advertisement content to be distributed. Then, the extraction unit 134 transmits the extracted item of advertisement content to be distributed, to the distribution unit 135 of the distribution apparatus 100.

The distribution unit 135 distributes the advertisement content received from the extraction unit 134 to the user terminals 10 (step S205).

### 6. Modifications

The distribution apparatus 100 according to the embodiment described above may be implemented in various different modes other than the above-mentioned embodiment. Therefore, other embodiments of the distribution apparatus 100 will be described below.

6-1. Weight Coefficient (1)

In the above-mentioned embodiment, the example has been described in which the calculation unit 132 calculates, as the weight coefficient in each time zone, a rate of the CTR in each time zone of the predetermined day to the entire CTR of the predetermined day. The calculation unit 132 may further correct the calculated weight coefficient in each time zone. Specifically, the calculation unit 132 may use the weight coefficient in a predetermined time zone, and weight in another time zone different from the predetermined time zone to correct the weight coefficient in the predetermined time zone. For example, the calculation unit 132 corrects the weight coefficient between one o'clock and two o'clock, using the weight coefficient in an immediately preceding time zone, between zero o'clock and one o'clock, or the weight coefficient in an immediately succeeding time zone, between two o'clock and three o'clock.

This point will be described using the following formula (3).

$${k}_{Ait} = \frac{{k}_{i ( t - l )} + {k}_{it} + {k}_{i ( t + l )}}{3} \qquad ( 3 )$$

Formula (3) is used for calculating the weight coefficient k_{Ait} obtained by correcting the weight kᵢₜ in the predetermined time zone, using the weight coefficient kᵢ₍ₜ₋₁₎ in a time zone immediately before the predetermined time zone, and the weight coefficient kᵢ₍ₜ₊₁₎ in a time zone immediately after the predetermined time zone, as the weight coefficient in another time zone.

For example, as the predetermined time zone, the weight coefficient between one o'clock and two o'clock will be considered. In the present embodiment, one weight coefficient is calculated by the calculation unit 132 in each time zone, in each item of advertisement content. This represents that, for example, the weight coefficient is constant even at 1:05 or 1:55, as the calculated weight coefficient between one o'clock and two o'clock. Here, it can be considered that the weight coefficient at 1:05 is influenced by the weight coefficient between zero o'clock and one o'clock, and further, the weight coefficient at 1:55 is influenced by the weight coefficient between two o'clock and three o'clock.

Therefore, as shown in formula (3), the calculation unit 132 may correct the weight coefficient kᵢₜ of advertisement content i in the predetermined time zone, in consideration of the influences of the weight coefficient kᵢ₍ₜ₋₁₎ in a time zone immediately before the time zone, and the weight coefficient kᵢ₍ₜ₊₁₎ in a time zone immediately after the time zone. It is noted that formula (3) represents an average value of the weight coefficient kᵢₜ, the weight coefficient kᵢ₍ₜ₋₁₎, and the weight coefficient kᵢ₍ₜ₊₁₎.

Here, the calculation unit 132 is not limited to the above-mentioned example, and may correct the weight coefficient, using the following formula (4).

$${k}_{Ait} = \frac{{k}_{i ( t - l )} + 2 {k}_{it} + {k}_{i ( t + l )}}{4} \qquad ( 4 )$$

Similarly to formula (3), formula (4) is used for correcting the weight coefficient kᵢₜ in the predetermined time zone, using the weight coefficient kᵢ₍ₜ₋₁₎ in a time zone immediately before the predetermined time zone, the weight coefficient kᵢ₍ₜ₊₁₎ in a time zone immediately after the predetermined time zone. That is, formula (4) represents an average value of the weight coefficient kᵢₜ, the weight coefficient kᵢ₍ₜ₋₁₎, and the weight coefficient kᵢ₍ₜ₊₁₎.

Here, a value “2” by which the weight coefficient kᵢₜ is multiplied represents a degree of importance, and the value is preferably an arbitrary value. That is, formula (4) represents that a numerical value shown by the corrected weight coefficient k_{Ait} is calculated as a value strongly influenced by the weight coefficient kᵢₜ, so that the degree of importance “2” is applied to the weight coefficient kᵢₜ. For example, when it is desired to calculate the numerical value shown by the corrected weight coefficient kᵢₜ, as a value strongly influenced by the weight coefficient kᵢ₍ₜ₋₁₎, the weight coefficient kᵢ₍ₜ₋₁₎ is preferably multiplied by a predetermined numerical value as the degree of importance.

The calculation unit 132 performs the correction process on all of the weight coefficients stored in the weight coefficient information storage unit 123. It is noted that the calculation unit 132 may store the weight coefficients corrected using the above formula (3) or (4), in the weight coefficient information storage unit 123 or a storage unit different from the weight coefficient information storage unit 123.

Therefore, the distribution apparatus 100 can correct the weight coefficient in the predetermined time zone, using the weight coefficient in another time zone different from the predetermined time zone. Therefore, the distribution apparatus 100 can increase the accuracy of the calculated weight coefficient.

6-2. Weight Coefficient (2)

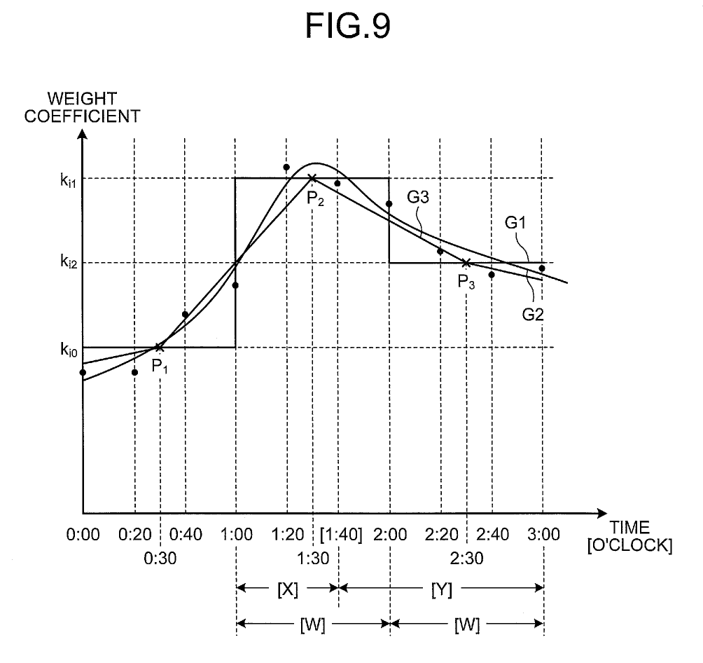

Further, in the above-mentioned embodiment, the calculation unit 132 may use the calculated weight in each time zone to calculate the weight in each time zone having a second time interval smaller than a first time interval of this time zone, in each item of advertisement content. Specifically, the calculation unit 132 calculates the weight in a time zone having the second time interval. A predetermined time zone and an adjacent time zone adjoining to the predetermined time zone are selected from the time zones having the first time interval, and the total time interval of them is divided based on a rate between two time intervals divided by the time zone having the second time interval included in the total time interval. This point will be described using FIG. 9.

FIG. 9 is a graph illustrating the weight coefficient calculation process for each time zone having a time interval smaller than a time interval corresponding to a first time interval. In FIG. 9, the vertical axis represents weight coefficient, and the horizontal axis represents time.

In the above-mentioned embodiment, the example has been described in which the calculation unit 132 calculates the weight coefficient in each one-hour time zone of the predetermined day, as the weight coefficient in each time zone. For example, the calculation unit 132 calculates the weight coefficient kᵢₜ in each one-hour time zone of the day, in the advertisement content i. Here, a graph G1 illustrated in FIG. 9 is a graph obtained by plotting the calculated weight coefficients kᵢₜ with respect to the corresponding time zones. Further, since the weight coefficient kᵢₜ has a constant value at any time in each time zone, the distribution CTR calculated based on such a weight coefficient kᵢₜ has a shape similar to that of the graph G1. For example, when the weight coefficient kᵢ₁ between one o'clock and two o'clock is defined as “0.02”, the weight coefficient kᵢ₁ has a constant value of “0.02” at any time between one o'clock and two o'clock, e.g., 1:00, 1:20, or 1:40. The same is applied to the other time zones.

The calculation unit 132 according to a modification calculates the weight coefficient in each time zone having a time interval smaller than one hour based on the weight coefficient in each one-hour time zone, to generate a graph G2 having a curve (e.g., spline curve) smoother than that of the graph G1. The process will be described focusing on a time between one o'clock and two o'clock. It is noted that the same process can be applied to the other time zone.

It is assumed that the calculation unit 132 has already calculated the weight coefficient in each one-hour time zone of the predetermined day. Here, calculation of a weight coefficient in each one-minute time zone, as the time interval smaller than one hour of the predetermined day, by the calculation unit 132 will be considered. Here, an example of calculation of the weight coefficient in a time between “1:40 and 1:41”, as the one-minute time zone, will be described.

First, the time interval of the one-hour time zone is defined as the first time interval “W”, and the time interval of the one-minute time zone is defined as the second time interval. It is noted that, taking 1:40 for example, the time interval of the one-minute time zone corresponds to 1:40 to 1:41.

Here, when a time between two o'clock and three o'clock is used as an adjacent time zone adjoining a time between one o'clock and two o'clock, the total time interval of a time between one o'clock and two o'clock and a time between two o'clock and three o'clock is defined as “2W”.

Focusing on a time between 1:40 and 1:41, this time interval “2W” is divided into two time intervals around a time between 1:40 and 1:41. In an example of FIG. 9, the time interval “2W” can be divided into time intervals “X” and “Y”. That is, the time interval “2W” is divided at a ratio of X:Y around 1:40.

In an example of FIG. 9, when actual values are adopted, the first time interval W can be considered as 60 minutes (2W corresponds to 120 minutes), X as 40 minutes, and Y as 80 minutes. That is, the following rate can be obtained: X:Y=1:2.

The calculation unit 132 calculates the weight coefficient at 1:40, based on this rate. Specifically, the calculation unit 132 performs the calculation process based on formula (5).

$${k}_{iT} = \frac{Y \times {k}_{it} + X \times {k}_{i ( t + l )}}{X + Y} \qquad ( 5 )$$

Formula (5) is used for calculation of a weight coefficient k_{iT} in a time zone T included in the time zone t and having a time interval smaller than one-hour time interval, using the weight coefficient kᵢₜ in the time zone t selected from one-hour time zones of the day, in the advertisement content i. Specifically, formula (5) represents calculation of the weight coefficient k_{iT} in the time zone T, using the weight coefficient kᵢₜ, when the total time interval of the time zone t and the adjacent time zone (t+1) is divided into X and Y, around the time zone T included in the time zone t.

The calculation unit 132 performs the calculation process every one minute, such as, in a time between 1:01 and 1:02, in a time between 1:02 to 1:03, in each one-hour time zone of the day. Therefore, the calculation unit 132 can calculate the weight coefficient in each one-minute time zone having a time interval smaller than one hour based on the weight coefficient in each one-hour time zone.

Although the example has been described in which when a weight coefficient in a time between 1:40 and 1:41 is calculated, the weight coefficient between two o'clock and three o'clock is used as a one-hour time zone adjoining the time zone between one o'clock and two o'clock, when for example the weight coefficient in a time between 1:20 to 1:21 is calculated, the weight coefficient between zero o'clock and one o'clock may be used. In this case, in formula (5), kᵢ₍ₜ₋₁₎ is used instead of kᵢ₍ₜ₊₁₎. This is based on consideration that time before 1:30 tends to be influenced by the weight coefficient between zero o'clock and one o'clock, and time after 1:30 tends to be influenced by the weight coefficient between two o'clock and three o'clock, around 1:30 as intermediate time. As described above, when the weight coefficient in each time zone having a time interval smaller than the predetermined time interval is calculated, the calculation unit 132 considers whether to use any of the weight coefficients of two time zones having the same time interval adjoining the time zone having a predetermined time interval.

Then, after the weight coefficient in each one-minute time zone is calculated, the calculation unit 132 generates a function for obtaining a weight coefficient, with time as a variable. Specifically, the calculation unit 132 generates a curve function of a curve (e.g., spline curve) expressed by plotting, against time, the weight coefficient in each one-minute time zone. Such a spline curve is expressed as a graph G2 illustrated in FIG. 9. Further, as described above, the distribution CTR is calculated by multiplying the predicted CTR by the weight coefficient, so that when distribution CTR is plotted on the vertical axis, a graph having a shape similar to that of the graph G2 is obtained.

Further, the calculation unit 132 may store the generated curve function in a predetermined storage unit, corresponding to the advertisement content. It is noted that the calculation unit 132 may store the calculated weight coefficient in each one-minute time zone, in a predetermined storage unit, corresponding to the advertisement content, without generating the curve function.

When receiving the acquisition request for advertisement content, the extraction unit 134 according to the above embodiment reads the curve function, inputs a time zone in which the acquisition request is received to this curve function, and calculates the weight coefficient of each item of advertisement content. The extraction unit 134 multiplies the predicted CTR for corresponding item of advertisement content by the calculated weight coefficient to calculate the distribution CTR, and extracts an item of advertisement content to be distributed based on the calculated distribution CTR. As described above, when storing the weight coefficient in each one-minute time zone, without generating the curve function, the extraction unit 134 acquires a weight coefficient in a one-minute time zone corresponding to a time zone in which the acquisition request for advertisement content is received.

Although the example has been described in which the calculation unit 132 calculates the weight coefficient in each one-minute time zone having a time interval smaller than one hour, from the weight coefficient in each one-hour time zone of the day, the calculated weight coefficient in each one-minute time zone may be used to further calculate the weight coefficient in each time zone having a smaller time interval, one-second time zone of the day.

As descried above, the distribution apparatus 100 uses the calculated weight coefficient in each predetermined time zone to calculate the weight coefficient in each time zone having a time interval smaller than a time interval corresponding to this time zone. Therefore, the distribution apparatus 100 can increase the accuracy of the advertisement evaluation value used for extraction of an item of content to be distributed.

6-3. Weight Coefficient (3)

The example has been described in the modification 6-2, in which the calculation unit 132 calculates the weight coefficient in each one-minute time zone having a time interval smaller than one hour, based on the rate between the time intervals, from the weight coefficient in each one-hour time zone of the day. However, the calculation unit 132 may calculate a weight coefficient in each time zone having a time interval smaller than one-hour interval of the day in a different manner. Specifically, in coordinates of intermediate time zone (e.g., a time between 1:30 and 1:31, between 2:30 and 2:31, . . . ) between one-hour time zones of the day, and a corresponding weight coefficient, the calculation unit 132 calculates the weight coefficient in each time zone having a time interval smaller than one-hour interval of the day, using a function formula representing each straight line connecting adjacent coordinates. This point will be described using FIG. 9.

In FIG. 9, the weight coefficient between zero o'clock and one o'clock is represented by kᵢ₀, the weight coefficient between one o'clock and two o'clock by kᵢ₁, the weight coefficient between two o'clock and three o'clock by kᵢ₂. Each weight coefficient indicates a constant value regardless of change in time in a corresponding time zone. Therefore, a weight coefficient in a time between 0:30 and 0:31 as an intermediate time zone of a time between zero o'clock and one o'clock can be considered as kᵢ₀, a weight coefficient in a time between 1:30 and 1:31 as the intermediate time zone of a time between one o'clock and two o'clock as kᵢ₁, a weight coefficient in a time between 2:30 and 2:31 as the intermediate time zone of a time between two o'clock and three o'clock as kᵢ₂.

Here, when coordinates of 0:30 and a corresponding weight coefficient kᵢ₀ is represented by coordinates P₁, coordinates of 1:30 and a corresponding weight coefficient kᵢ₁ as coordinates P₂, coordinates of 2:30 and a corresponding weight coefficient kᵢ₂ as coordinates P₃, adjacent coordinates, i.e., P₁ and P₂, P₂ and P₃ connected by straight lines, respectively, represent a line graph G3 illustrated in FIG. 9. Although not illustrated, the coordinates P₁ are further connected to coordinates of 23:30 and a corresponding weight coefficient, and the coordinates P₃ are further connected to coordinates of 3:30 and a corresponding weight coefficient. Further, coordinates corresponding to the other intermediate time zones, not illustrated, are connected in a similar manner.

The calculation unit 132 calculates, based on this line graph G3, the weight coefficient in each time zone having a time interval smaller than one-hour interval of the day. A specific process of the calculation will be described below.

Here, an example will be described in which the calculation unit 132 calculates the weight coefficient in a time between 1:40 and 1:41 as the weight coefficient in each one-minute time zone having a time interval smaller than one hour, based on the line graph G3.

Since a time between 1:40 and 1:41 is a time zone between 1:30 and 2:30, the calculation unit 132 substitutes a value corresponding to 1:40 in a function formula representing the straight line connecting the coordinates P₂ and the coordinates P₃ of the line graph G3 to calculate the weight coefficient in a time between 1:40 and 1:41.

The calculation unit 132 performs the calculation process every one minute, such as, in a time between 1:01 and 1:02, in a time between 1:02 to 1:03, in each one-hour time zone of the day. Therefore, the calculation unit 132 can calculate the weight coefficient in each one-minute time zone having a time interval smaller than one hour based on the weight coefficient in each one-hour time zone.

6-4. Storage of Various Evaluation Values and Weight Coefficient Values for Each Period Type

The distribution apparatus 100 according to an embodiment may store the distribution result for each period type such as a weekday, a holiday, or a season. That is, the distribution result storage unit 122 illustrated in FIG. 5 is provided for each period type. Further, according to this, the weight coefficient information storage unit 123 may be also provided for each period type. In this configuration, the calculation unit 132 of the distribution apparatus 100 calculates the weight coefficient from a distribution result storage unit 122 corresponding to each period type, and stores the calculated weight coefficient in a weight coefficient information storage unit 123 for a corresponding period type.

For example, when receiving the acquisition request for advertisement content on a holiday, the extraction unit 134 uses a weight coefficient information storage unit 123 storing holiday data to acquire a weight coefficient corresponding to a time zone in which the acquisition request for advertisement content is received. Then, the extraction unit 134 uses the acquired weight coefficient to calculate the distribution CTR, and extract an item of advertisement content to be distributed based on the calculated distribution CTR. Therefore, the distribution apparatus 100 can highly accurately extract the content to be distributed.

6-5. Number of Impressions

Further, in the above-mentioned embodiment, when the number of times of distribution of content is insufficient to calculate the weight coefficient, the calculation unit 132 may perform a process of specifying a group for calculating the weight coefficient. Specifically, for calculation of the weight coefficient, when the number of times of distribution of content (number of impressions) in a predetermined time zone is not more than a predetermined threshold, the calculation unit 132 uses an evaluation value of another item of content relating to this content and calculates the weight of this item of content.

That is, when an item of content belongs to a plurality of groups, the groups have different numbers of affiliate items of content belonging to the groups, and a total value of the number of times of display of each affiliate item of content in the predetermined time zone is larger than a predetermined threshold in a certain group of the groups, the calculation unit 132 uses an evaluation value of the affiliate items of content belonging to the certain group to calculate the weight of the content.

This point will be described further specifically. Each item of advertisement content may belong to a plurality of groups. Each of the groups has a predetermined group hierarchy. As the group hierarchy, for example, “first layer: advertisement content, second layer: advertisement group, third layer: campaign, fourth layer: account, fifth layer: account category, sixth layer: merchandise product for advertiser, seventh layer: whole” are considered. Further, the number of items of advertisement content belonging to each group is different, and here, a larger hierarchy has a larger number of items of advertisement content.

The “advertisement content” of the group hierarchy represents each item of advertisement content. For example, when the number of impressions of the corresponding item of advertisement content satisfies the threshold, the calculation unit 132 uses the number of impressions of the item of advertisement content to calculate the weight coefficient. Further, the “advertisement group” represents, for example, a group which may be arbitrarily set by for example the advertisement distributor. Further, the “campaign” represents a type (campaign ID) of campaign which may be assigned to each item of advertisement content. Further, the “account” corresponds to an advertiser ID of the advertiser submitting each item of advertisement content. Further, the “account category” represents a category to which each advertiser belongs. For example, the account category includes a “car” (in this case, a target advertiser is a car sales corporation or the like), or “cosmetics” (in this case, the target advertiser a cosmetics maker or the like).

Further, the “merchandise product for advertiser” represents a merchandise product relating to advertisement distribution provided by the advertisement distributor. For example, as the merchandise product “M”, “advertisement display site: MM opening page, advertising spot type: mm, advertisement data format: image data”, or the like are provided by the advertisement distributor. The advertiser bids for advertisement content of him-/her-self to the merchandise product for advertiser. The “whole” represents the whole items of advertisement content submitted in the distribution apparatus 100.

Here, an example of a process of specifying the group for calculating the weight coefficient will be described using FIGS. 4 and 5. First, it is assumed that “1000” is previously set to the distribution apparatus 100, as the threshold for the number of impressions in each time zone required for the weight coefficient calculation process for each time zone. Here, the calculation of the weight coefficient of an item AD12 of advertisement content in a time between 23 o'clock and 24 o'clock by the calculation unit 132 will be considered, using FIG. 5.

Since the item AD12 of advertisement content in a time between 23 o'clock and 24 o'clock has a number of impressions of “980”, the calculation unit 132 determines that the threshold “1000” is not satisfied in the “advertisement content” as a first layer group. Then, the calculation unit 132 determines whether the “advertisement group” as a second layer group satisfies the threshold “1000”.

For example, the item AD12 of advertisement content is assumed to belong to an advertisement group “L”. In this configuration, the calculation unit 132 determines whether the total value of the number of impressions in a time between 23 o'clock and 24 o'clock satisfies the threshold “1000”, in an item of advertisement content belonging to the advertisement group “L”. Although not illustrated, here, it is assumed that the calculation unit 132 determines that the total value of the number of impressions does not satisfy the threshold “1000”.

Then, the calculation unit 132 determines whether the “campaign” as a third layer group satisfies the threshold “1000”. According to FIG. 4, the item AD12 of advertisement content belongs to the campaign ID “CP10”. An item AD11 of advertisement content and an item AD13 of advertisement content also belong to the campaign ID “CP10”. Therefore, in the items AD11 to AD13 of advertisement content advertisement content, the calculation unit 132 determines whether the total value of the number of impressions in a time between 23 o'clock and 24 o'clock satisfies the threshold “1000”.

Returning to FIG. 5, the item AD11 of advertisement content indicates “1100”, the item AD12 of advertisement content indicates “980”, and the item AD13 of advertisement content indicates “1050”, as the number of impressions in a time between 23 o'clock and 24 o'clock. Since the total value of them indicates “3130”, the calculation unit 132 determines that the items AD11 to AD13 of advertisement content satisfy the threshold “1000, and specifies the campaign ID “CP10” as the group for calculating the weight coefficient of the item AD12 of advertisement content in a time between 23 o'clock and 24 o'clock.

The calculation unit 132 calculates a CTR in a time between 23 o'clock and 24 o'clock, in the advertisement content belonging to the campaign ID “CP10”. Specifically, since the items AD11 to AD13 of advertisement content belong to the campaign ID “CP10”, the calculation unit 132 divides the total value “66+49+42” of the number of clicks of the items AD11 to AD13 of advertisement content in a time between 23 o'clock and 24 o'clock, by the total value “3130” of the number of impressions of the items AD11 to AD13 of advertisement content in a time between 23 o'clock and 24 o'clock, and the CTR of the advertisement content belonging to the campaign ID “CP10” in a time between 23 o'clock and 24 o'clock is calculated. The calculation unit 132 uses a CTR value of “0.05” obtained by such a calculation as the CTR of the item AD12 of advertisement content in a time between 23 o'clock and 24 o'clock, and calculates the weight coefficient of the item AD12 of advertisement content in a time between 23 o'clock and 24 o'clock.

The example has been described which is configured such that the total value of the number of impressions in a time between 23 o'clock and 24 o'clock satisfies the threshold “1000”, in the items of advertisement content belonging to the “campaign” as the third layer group, but the calculation unit 132 determines whether the threshold is satisfied in order of the fourth layer “account”, the fifth layer “account category”, the sixth layer “merchandise product for advertiser”, and the seventh layer “whole”.

It is noted that the process of specifying the group for calculating the weight coefficient may be performed at a portion other than the calculation unit 132 at any appropriate time. For example, the process of specifying the group for calculating the weight coefficient may be performed by the distribution unit 135, and the distribution unit 135 may perform the process of specifying the group for calculating the weight coefficient for each item of advertisement content, upon calculation of the CTR in each time zone. Further, the distribution unit 135 may perform the process of specifying the group for calculating the weight coefficient, upon calculation of the entire CTR of the day.

In the specified group, the distribution unit 135 uses the number of impressions and the number of clicks of the items of advertisement content belonging to the group to calculate the CTR of the corresponding time zone. Further, the distribution unit 135 may store the calculated CTR in the distribution result storage unit 122.

It is noted that the group types described as layers, the order of layers, or the number of layers is not limited to this example. That is, they may be arbitrarily set. Further, the process of specifying the group for calculating the weight coefficient may be performed not only on the number of impressions, but also on the number of clicks. In this case, a predetermined threshold is previously set to the number of clicks used for calculating the weight coefficient in each time zone.

As described above, when the number of impressions in a predetermined time zone is not more than a predetermined threshold, the distribution apparatus 100 uses the evaluation value of items of content of a group including a total value of the numbers of impressions satisfying the predetermined threshold, of a plurality of groups including corresponding items of content to calculate the weight coefficient. Therefore, the distribution apparatus 100 can evade reduction in accuracy of the evaluation value or the weight coefficient of content calculated using the number of impressions, due to the reduced number of impressions.

6-6. Calculation of Distribution CTR

In the above-mentioned embodiment, the example has been described in which the distribution apparatus 100 calculates the weight coefficient in each time zone as the rate of the CTR in each time zone of the predetermined day, to the entire CTR of the day, and multiplies the predicted CTR for the day by a weight coefficient in an arbitrary time zone, selected from the calculated weight coefficients to calculate the distribution CTR. However, the distribution apparatus 100 may correct the entire CTR to a value in consideration of the time zone by multiplying the entire CTR of the predetermined day by the weight coefficient corrected in the process described in modification 6-1 or the weight coefficient calculated in the process described in modification 6-2. Further, the distribution apparatus 100 may use, as the distribution CTR, the CTR obtained by inputting the corrected entire CTR to the predicted CTR.

For example, when receiving an advertisement content acquisition request, the distribution apparatus 100 acquires a weight coefficient corresponding to a time zone in which the advertisement content acquisition request is received. For example, based on modification 6-1, the distribution apparatus 100 acquires the weight coefficient in a corresponding time zone, for each item of advertisement content, from the weight coefficient information storage unit 123 storing the corrected weight coefficient. While, based on modification 6-2, the distribution apparatus 100 inputs the corresponding time zone to the curve function for reach item of advertisement content to acquire the weight coefficient of each item of advertisement content in the time zone.

The distribution apparatus 100 multiplies the entire CTR of the corresponding item of advertisement content in the corresponding day by the acquired weight coefficient. That is, the distribution apparatus 100 corrects the entire CTR to a value in consideration of time, using the weight coefficient. The distribution apparatus 100 inputs the corrected entire CTRs to the predicted CTRs for corresponding item of advertisement content to calculate the distribution CTR for each item of advertisement content. Further, the distribution apparatus 100 compares the calculated distribution CTRs to extract an item of advertisement content to be distributed from items of advertisement content.

6-7. Apparatus Configuration

Further, in the above-mentioned embodiment, the example has been described in which the advertisement distribution system 1 includes the information providing apparatus 30 and the distribution apparatus 100, but the information providing apparatus 30 and the distribution apparatus 100 may be formed as one apparatus. When receiving the acquisition request for web page from the user terminal 10, the distribution apparatus 100 distributes a web page not including an advertisement acquisition command to the user terminals 10, together with an item of advertisement content extracted from the advertisement content storage unit 121.

6-8. Others

It is noted that the example has been described in which the distribution apparatus 100 extracts an item of advertisement content, the distribution apparatus 100 is not limited to this example. For example, the distribution apparatus 100 may perform the above-mentioned extraction process on content other than the advertisement content for advertisement.

Further, the example has been described in which the distribution apparatus 100 calculates the weight coefficient in each one-hour time zone in the predetermined day, but the distribution apparatus 100 is not limited to this example. For example, the distribution apparatus 100 may calculate a weight coefficient in each time zone having a time interval of an arbitrary period (e.g., two hours, half a day, or the like) of the predetermined day.

Further, in the processes having been described in the above-mentioned embodiment, all or part of the processes having been described to be performed automatically may be also performed manually, or all or part of the processes having been described to be performed manually may be performed automatically by a known method. Additionally, the procedure in the description or the drawings, specific names, information including various data or parameters can be changed arbitrarily, unless otherwise designated.

Further, component elements of each apparatus illustrated in the drawings represent a functional concept, and are not necessarily configured physically as illustrated in the drawings. That is, the specific mode of distribution or integration of each apparatus is not limited to the one as illustrated in the drawings. The whole or part thereof may be distributed or integrated functionally or physically in any units according to various kinds of loads, usage conditions, or the like.

Further, the above-mentioned embodiments can be appropriately combined within a range consistent with the processing contents.

6-9. Program

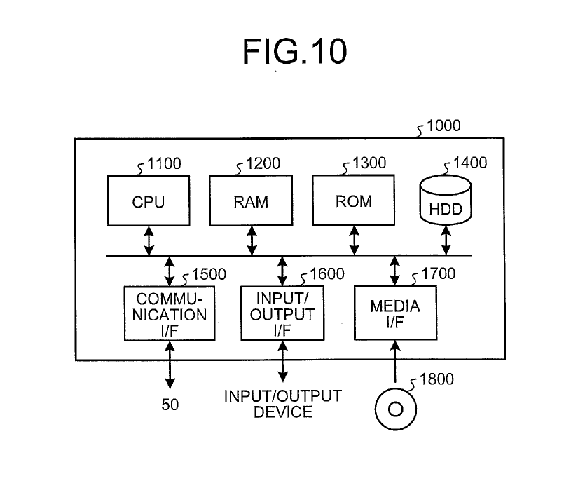

Further, the distribution apparatus 100 according to the above-mentioned embodiment includes for example a computer 1000 having a configuration as illustrated in FIG. 10. An example of the distribution apparatus 100 will be described below. FIG. 10 is a hardware configuration diagram illustrating an example of the computer 1000 embodying functions of the distribution apparatus 100. The computer 1000 includes a CPU 1100, a RAM 1200, a ROM 1300, an HDD 1400, a communication interface (I/F) 1500, an input/output interface (I/F) 1600, and a media interface (I/F) 1700.

The CPU 1100 is operated based on programs stored in the ROM 1300 or the HDD 1400, and controls each units. The ROM 1300 stores a boot program executed by the CPU 1100 upon booting the computer 1000, programs depending on hardware of the computer 1000, and the like.

The HDD 1400 stores programs executed by the CPU 1100, data used for such programs, and the like. The communication interface 1500 receives data from another device through a communication network 50, and transmits the data to the CPU 1100, and further, transmits data generated by the CPU 1100 to the another device through the communication network 50.

The CPU 1100 controls an output device such as a display or a printer, and an input device such as a keyboard or a mouse, through the input/output interface 1600. The CPU 1100 acquires data from the input device through the input/output interface 1600. Further, the CPU 1100 outputs generated data to the output device through the input/output interface 1600.

The media interface 1700 reads programs or data stored in a recording medium 1800, and provides the program or data to the CPU 1100 through the RAM 1200. The CPU 1100 loads such programs from the recording medium 1800 on the RAM 1200 through the media interface 1700, and executes the loaded programs. The recording medium 1800 includes for example an optical recording medium such as a digital versatile disc (DVD), or phase change rewritable disk (PD), a magnetooptical recording medium such as a magneto-optical disk (MO), a tape medium, a magnetic recording medium, or a semiconductor memory.

For example, when the computer 1000 functions as the distribution apparatus 100 according to an embodiment, the CPU 1100 of the computer 1000 executes the programs loaded on the RAM 1200 to achieve the function of the control unit 130. Further, the HDD 1400 stores data in the storage unit 120. The CPU 1100 of the computer 1000 reads these programs from the recording medium 1800 and executes these programs, but may acquire these programs from another apparatus through the communication network 50, as another example.

### 7. Effects

As described above, the distribution apparatus 100 according to an embodiment includes a calculation unit 132, and an extraction unit 134. The calculation unit 132 calculates the weight of each item of content in each time zone, based on the evaluation value of each item of content in each time zone. The extraction unit 134 extracts content to be distributed in an arbitrary time zone from multiple items of content, based on the weight in each time zone calculated by the calculation unit 132.

Further, in the distribution apparatus 100 according to an embodiment, the calculation unit 132 calculates, as the weight in each time zone, the rate of an evaluation value in each corresponding time zone to the evaluation value of content in a predetermined period including the corresponding time zone.

Therefore, the distribution apparatus 100 according to an embodiment can preferentially extract an item of content having a higher evaluation value, in a time zone in which the acquisition request for content is received. That is, the distribution apparatus 100 can prevent deviation in extraction of an item of content, e.g., extraction of a specific item of content as the distribution target in any time zone, and can extract a suitable item of content, as the content to be distributed, according to the time zone. Therefore, the distribution apparatus 100 can increase profits obtained by the distribution of content or increase the advertising effect.

Further, in the distribution apparatus 100 according to an embodiment, the calculation unit 132 uses the weight in a predetermined time zone, and weight in another time zone different from the predetermined time zone to correct the weight coefficient in the predetermined time zone.

Therefore, the distribution apparatus 100 according to an embodiment can make, to the weight in a predetermined time zone, consideration of the influence of the weight in a time zone different from the predetermined time zone, and can increase the accuracy of the evaluation value of content used for extraction of an item of content to be distributed.

Further, in the distribution apparatus 100 according to an embodiment, the calculation unit 132 uses, as the weight in another time zone, the weight in a time zone immediately before the predetermined time zone, or the weight in a time zone immediately after the predetermined time zone, and corrects the weight of the predetermined time zone.

Therefore, the distribution apparatus 100 according to an embodiment can make, to the weight in the predetermined time zone, consideration of the influence of the weight in a time zone immediately before the predetermined time zone or the weight in a time zone immediate after the predetermined time zone, and can increase the accuracy of the evaluation value of content used for extraction of an item of content to be distributed.

Further, in the distribution apparatus 100 according to an embodiment, the calculation unit 132 uses the weight in each time zone to calculate the weight in each time zone having a second time interval smaller than the first time interval of the corresponding time zone.

Therefore, the distribution apparatus 100 according to an embodiment can use the calculated weight in each predetermined time zone to calculate the weight in each time zone having a time interval smaller than the time interval corresponding to the corresponding time zone, and can increase the accuracy of the evaluation value of content used for extraction of an item of content to be distributed.

Further, in the distribution apparatus 100 according to an embodiment, the calculation unit 132 calculates the weight in a time zone having the second time interval. A predetermined time zone and an adjacent time zone adjoining to the predetermined time zone are selected from the time zones having the first time interval, and the total time interval of them is divided based on a rate between two time intervals divided by the time zone having the second time interval included in the total time interval.

Therefore, when extracting an item of content to be distributed, the distribution apparatus 100 according to an embodiment can calculate the evaluation value of content further suitable for a time zone to be extracted, and can distribute content further suitable for the time zone.

Further, in the distribution apparatus 100 according to an embodiment, when the number of times of distribution of content in a predetermined time zone is not more than the predetermined threshold, the calculation unit 132 uses the evaluation value of another item of content relating to this content and calculates the weight of this item of content.

Therefore, the distribution apparatus 100 according to an embodiment can evade reduction in accuracy of the evaluation value or the weight of content calculated using the number of times of distribution of the content, due to the reduced number of times of distribution of the content.

Further, in the distribution apparatus 100 according to an embodiment, when an item of content belongs to a plurality of groups, the groups have different numbers of affiliate items of content belonging to the groups, and the total value of the number of times of display of each affiliate item of content in the predetermined time zone is larger than the predetermined threshold in a certain group of the groups, the calculation unit 132 uses the evaluation value of the affiliate items of content belonging to the certain group to calculate the weight of the content.

Therefore, the distribution apparatus 100 according to an embodiment can evade reduction in accuracy of the evaluation value or the weight of content calculated using the number of times of distribution of the content, due to the reduced number of times of distribution of the content.

The embodiments of the present application have been described in detail based on the drawings, but which are given by way of example, and the present invention can be carried out in other modes to which various modifications and improvements are applied based on the knowledge of those skilled in the art, including the modes described in “Summary of the Invention”.

Further, the “section, module, or unit” can be replaced with “means”, a “circuit”, or the like. For example, the calculation unit can be replaced with calculation means or a calculation circuit.

According to one aspect of an embodiment, suitable item of advertisement content can be effectively extracted as the distribution target.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

1. An extraction apparatus comprising:
a calculation unit configured to calculate a weight of each item of content in each time zone, based on an evaluation value of each item of content in each time zone; and
an extraction unit configured to extract an item of content to be distributed in an arbitrary time zone from the items of content, based on the weight in each time zone calculated by the calculation unit.

2. The extraction apparatus according to claim 1,
wherein the calculation unit calculates, as the weight in each time zone, a rate of an evaluation value in each corresponding time zone to the evaluation value of content in a predetermined period including the corresponding time zone.

3. The extraction apparatus according to claim 1,
wherein the calculation unit uses the weight in a predetermined time zone, and a weight in another time zone different from the predetermined time zone to correct the weight in the predetermined time zone.

4. The extraction apparatus according to claim 3,
wherein the calculation unit uses, as the weight in another time zone, the weight in a time zone immediately before the predetermined time zone, or the weight in a time zone immediately after the predetermined time zone, and corrects the weight of the predetermined time zone.

5. The extraction apparatus according to claim 1,
wherein the calculation unit uses the weight in each time zone to calculate a weight in each time zone having a second time interval smaller than a first time interval of the corresponding time zone.

6. The extraction apparatus according to claim 5,
wherein the calculation unit calculates a weight in a time zone having the second time interval, a predetermined time zone and an adjacent time zone adjoining to the predetermined time zone being selected from the time zones having the first time interval, a total time interval of the predetermined time zone and the adjacent time zone being divided based on a rate between two time intervals divided by the time zone having the second time interval included in the total time interval.

7. The extraction apparatus according to claim 1,
wherein when the number of times of distribution of the content in a predetermined time zone is not more than a predetermined threshold, the calculation unit uses an evaluation value of another item of content relating to the content and calculates a weight of the item of content.

8. The extraction apparatus according to claim 7,
wherein when the item of content belongs to a plurality of groups, the groups have different numbers of affiliate items of content belonging to the groups, and a total value of the number of times of display of each affiliate item of content in the predetermined time zone is larger than the predetermined threshold in a certain group of the groups, the calculation unit uses an evaluation value of the affiliate items of content belonging to the certain group to calculate the weight of the content.

9. The extraction apparatus according to claim 1,
wherein the calculation unit uses, as the evaluation value, a selection rate of the number of times of selection of the content to the number of times of distribution of the content, or a fee changed according to the number of times of selection of the content, and charged to a provider of the content, or both of the selection rate and the fee charged.

10. An extraction method performed by an extraction apparatus, comprising:
calculating a weight of each item of content in each time zone, based on an evaluation value of each item of content in each time zone; and
extracting an item of content to be distributed in an arbitrary time zone from the items of content, based on the weight in each time zone calculated by the calculating.

11. A non-transitory computer readable storage medium having stored therein a extraction program causing a computer to perform:
calculating a weight of each item of content in each time zone, based on an evaluation value of each item of content in each time zone; and
extracting an item of content to be distributed in an arbitrary time zone from the items of content, based on the weight in each time zone calculated by the calculating.
